(19) United States
(12) Patent Application Publication
(10) Pub. No.: US 2007/0132693 A1
(43) Pub. Date: Jun. 14, 2007

(54) Image display device

(75) Inventors: Hajime Akimoto, Kokubunji (JP); Hiroshi Kageyama, Hachioji (JP); Tohru Kohno, Kokubunji (JP); Masayoshi Kinoshita, Hachioji (JP)

Correspondence Address: MILES & STOCKBRIDGE PC, 1751 PINNACLE DRIVE, SUITE 500, MCLEAN, VA, 22102-3833, US

(73) Assignee: Hitachi Displays, Ltd.

(21) Appl. No.: 11/604,850

(22) Filed: Nov. 28, 2006

(30) Foreign Application Priority Data
Nov. 30, 2005 (JP) 2005-345342

(51) Int. Cl. G09G 3/36

(52) U.S. Cl. 345/92

(57) ABSTRACT

An object of the present invention is to provide an image display device that is capable of displaying an image with high brightness and low power.

The above object is achieved by controlling, by use of a common switch control line 9, a pair of switching means 7, 8 for alternatively selecting and inputting one of the video signal voltage from a signal line DAT and the pixel driving voltage from a signal line SWP.

### CLAIM OF PRIORITY

The present application claims priority from Japanese application JP 2005-345342, filed on Nov. 30, 2005, the content of which is hereby incorporated by reference into this application.

### BACKGROUND OF THE INVENTION

1. Field of the Invention

The present invention relates to an image display device that is capable of displaying an image with high brightness and low power.

2. Description of the Related Art

The related art will be described with reference to FIG. 15. First of all, a configuration in the related art will be described.

FIG. 15 is a circuit diagram illustrating a pixel circuit of an organic EL (Electro Luminescence) display according to the related art. Each pixel 201 is provided with an organic EL element 202. One end of the organic EL element 202 is connected to a common electrode 203. The other end of the organic EL element 202 is connected to a power line PWR through a drive TFT (Thin Film Transistor) 204. A reset switch 205 is connected between a gate and drain of the drive TFT 204. In addition, the gate of the drive TFT 204 is connected through a storage capacitance 206 to a pixel switch 207 that is connected to a signal line DAT. The gate of the drive TFT 204 is also connected to a triangular wave switch 208 that is connected to a triangular wave line SWP.

Incidentally, the reset switch 205, the pixel switch 207, and the triangular wave switch 208 are controlled by a reset switch control line 211, a pixel switch control line 209, and a triangular wave switch control line 210 respectively.

Next, operation of the related art will be described.

In a pixel that is selected to be written, firstly the pixel switch 207 is switched ON by use of the pixel switch control line 209, and the reset switch 205 is switched ON by use of the reset switch control line 211. The triangular wave switch 208 is switched OFF by use of the triangular wave switch control line 210. At this time, an electric current flows from the power line PWR to the organic EL element 202 through the drive TFT 204 that is diode-connected.

Here, the drive TFT 205 and the organic EL element 202 constitute an inverter circuit in which a gate of the drive TFT 204 is used as input, whereas the middle point of the drive TFT 204 and the organic EL element 202 is used as output. In this case, the input and output of the inverter circuit are short-circuited by the reset switch 205.

The input middle point voltage is generated at the input/output of this inverter circuit upon inversion by means of the inverter. This input middle point voltage is input into one end of a storage capacitance 206. In addition, the signal voltage, which is applied to the signal line DAT at this point of time, is input into the other end of the storage capacitance 206 through the pixel switch 207.

Next, when the reset switch 205 is switched OFF by use of the reset switch control line 211, the difference voltage between the input middle point voltage and the signal voltage is stored in the storage capacitance 206. Up to this point, the write operation is completed.

Next, when the writing proceeds to a pixel in the next row, the pixel switch 207 is switched OFF by use of the pixel switch control line 209. At the same time, the triangular wave switch 208 is turned ON by use of the triangular wave switch control line 210.

At this point of time, the sweep voltage having a triangular wave form is applied to the triangular wave line SWP. This triangular wave voltage is input through the triangular wave switch 208 into the other end of the storage capacitance 206. Here, this triangular wave voltage is approximately the voltage that includes the signal voltage. Accordingly, when the triangular wave voltage becomes equal to the signal voltage that has been previously written, the storage capacitance 206 causes the previous middle point voltage to be regenerated at the gate of the drive TFT 204. To be more specific, based on the difference between the triangular wave voltage and the written signal voltage, it is possible to control, on a time basis, ON/OFF of the output of the inverter circuit in which the middle point of the drive TFT 204 and the organic EL element 202 is used as the output.

When this inverter circuit is in an ON state, the organic EL element 202 is in an ON state (emits light). On the other hand, when this inverter circuit is in an OFF state, the organic EL element 202 is in an OFF state (does not emit light). Therefore, for the specified triangular wave voltage, the control of the signal voltage makes it possible to control an ON period during one frame period of each pixel, and thereby to display an image on an organic EL display. For example, such a related art is described in detail in Japanese Patent Application Laid-Open No. 2003-5709.

### SUMMARY OF THE INVENTION

In the above-described related art, as shown in FIG. 15, each pixel requires three control lines in the longitudinal direction and three control lines in the lateral direction. With this arrangement, in particular a bottom emission type organic EL element has a problem that the area used to form the organic EL element becomes narrower due to the wiring, which causes the brightness to decrease. If the voltage of the power supply applied to the organic EL element is increased, the brightness is increased. In this case, however, the power consumption increases. This makes the problem worse when an improvement in properties is attempted by newly forming more TFT switches and more control lines in the pixel, or when a display with higher definition is developed by narrowing the pitch of each pixel.

An object of the present invention, therefore, is to provide an image display device that is capable of displaying an image with high brightness and low power.

An example of typical means included in the present invention, which is disclosed in this specification, will be described as follows.

To be more specific, according to one aspect of the present invention, an image display device comprises:

means for generating a video signal voltage;

means for generating a pixel driving voltage;

a pixel that includes a light emitting element whose brightness is controlled by the potential difference between the video signal voltage and the pixel driving voltage, and control means for controlling the brightness of the light emitting element; and

a display unit on which a plurality of pixels are arranged,

wherein:

the pixel includes a pair of switching means for alternatively selecting and inputting one of the video signal voltage and the pixel driving voltage; and

the pair of switching means has a structure that is controlled by a common switch control line.

It is possible to solve the problem that the area used to form the organic EL element becomes narrower as a result of increasing the number of lines in each pixel which causes the brightness to decrease, without increasing the power consumption.

### BRIEF DESCRIPTION OF THE DRAWINGS

FIG. 1 is a diagram illustrating a configuration of an organic EL display of an image display device according to a first embodiment of the present invention;

FIG. 2 is a circuit diagram illustrating a pixel circuit according to the first embodiment;

FIG. 3 is a diagram illustrating a layout configuration of a pixel according to the first embodiment;

FIG. 4 is a timing chart illustrating operation of a pixel according to the first embodiment;

FIG. 5 is a timing chart illustrating operation at the time of writing a signal voltage to a pixel according to the first embodiment;

FIG. 6 is a waveform chart illustrating the signal voltage and a triangular wave voltage according to the first embodiment;

FIG. 7 is a circuit diagram illustrating a pixel circuit according to a second embodiment of the present invention;

FIG. 8 is a timing chart illustrating operation at the time of writing a signal voltage to a pixel according to the second embodiment;

FIG. 9 is a diagram illustrating a configuration of an organic EL display used for portable telephones according to a third embodiment of the present invention;

FIG. 10 is a circuit diagram illustrating a pixel circuit according to a third embodiment;

FIG. 11 is a waveform chart illustrating a signal voltage and a voltage applied to a constant voltage line, according to the third embodiment;

FIG. 12 is a circuit diagram illustrating a pixel circuit according to a fourth embodiment of the present invention;

FIG. 13 is a timing chart illustrating operation of a pixel according to the fourth embodiment;

FIG. 14 is a diagram illustrating a configuration of a TV image display device according to a fifth embodiment of the present invention; and

FIG. 15 is a diagram illustrating a related art of a pixel circuit of an organic EL display.

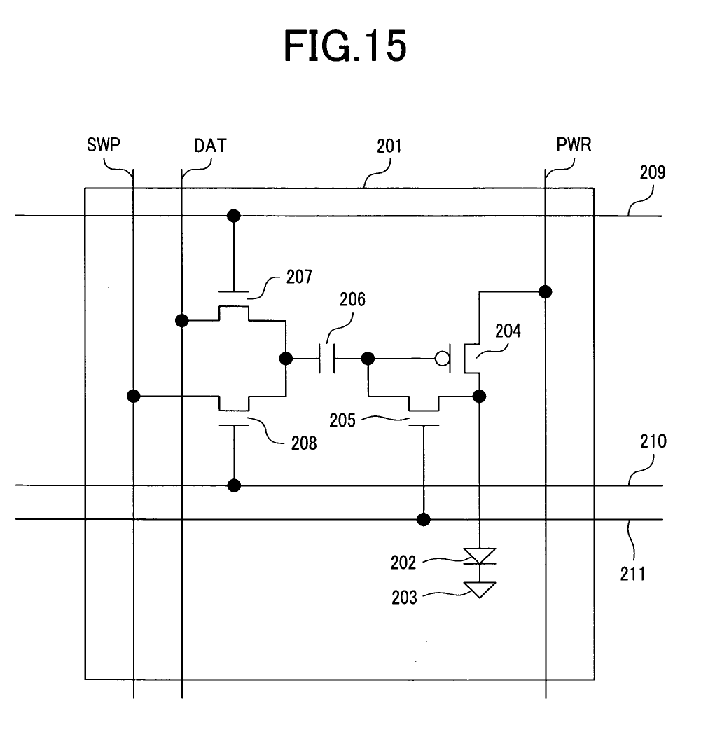

### DESCRIPTION OF THE PREFERRED EMBODIMENT

Embodiments of an image display device according to the present invention will be described in detail with reference to the accompanying drawings as below.

### First Embodiment

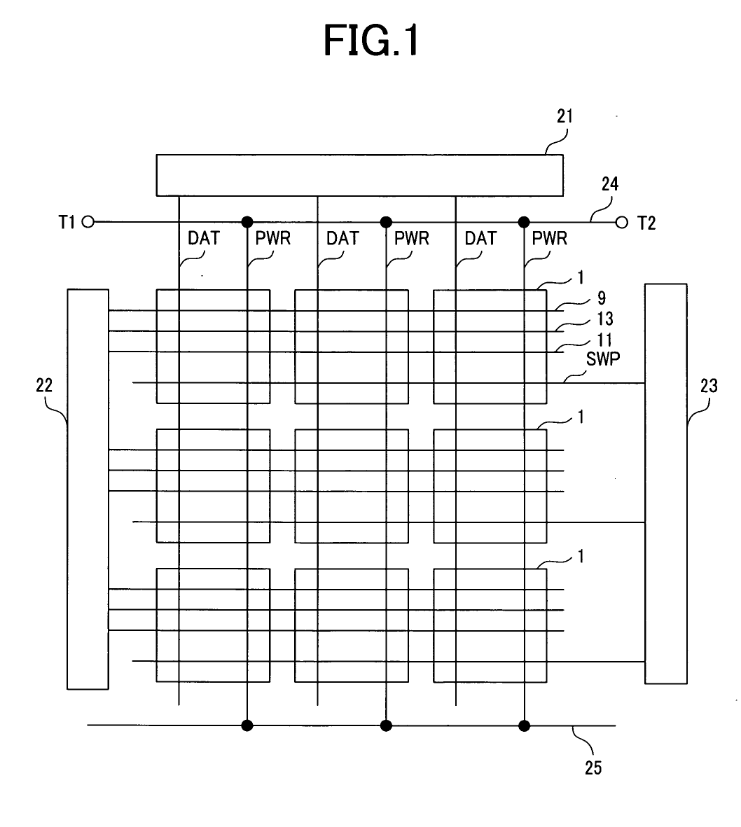

Configurations and operations of an image display device according to a first embodiment of the present invention will be successively described with reference to FIGS. 1 through 6. FIG. 1 is a diagram illustrating a configuration of an organic EL display used for portable telephones according to the first embodiment. In a display area, pixels 1 are located in a matrix form. Each signal line DAT is connected to each of the corresponding pixels 1 in the vertical direction. Each pixel switch control line 9, each light-emission control switch control line 13, and each reset switch control line 11 are connected to each of the corresponding pixels 1 in the horizontal direction. One end of each signal line DAT is connected to a signal-voltage output circuit 21. One end of each pixel switch control line 9, one end of each light-emission control switch control line 13, and one end of each reset switch control line 11 are connected to a scanning circuit 22. In addition, each power line PWR is connected to each of the corresponding pixels 1 in the vertical direction. The upper end of each power line PWR is connected to a main power supply line 24; and the lower end of each power line PWR is connected to a sub-power line 25. Each end of the main power supply line 24 is connected to each of connection terminals T1, T2, which are provided on the right and left sides of a panel. Moreover, each triangular wave line SWP is connected to each of the corresponding pixels 1 in the horizontal direction. One end of the each triangular wave line SWP is connected to a triangular wave generation circuit 23.

Only nine pixels are illustrated in FIG. 1 to simplify the diagram. However, the number of pixels is actually calculated as 320 (in the horizontal direction)×RGB×240 (in the vertical direction). Incidentally, all of the pixels in the display area, the scanning circuit 22, and the triangular-wave generation circuit 23 are formed on the same glass substrate by use of a polycrystalline Si-TFT element. The signal-voltage output circuit 21, whose signal voltage is a video signal voltage, is formed in a manner that a driver IC (Integrated Circuit) chip formed of monocrystal Si is placed on the glass substrate.

Next, how each of the pixels 1 is configured will be described.

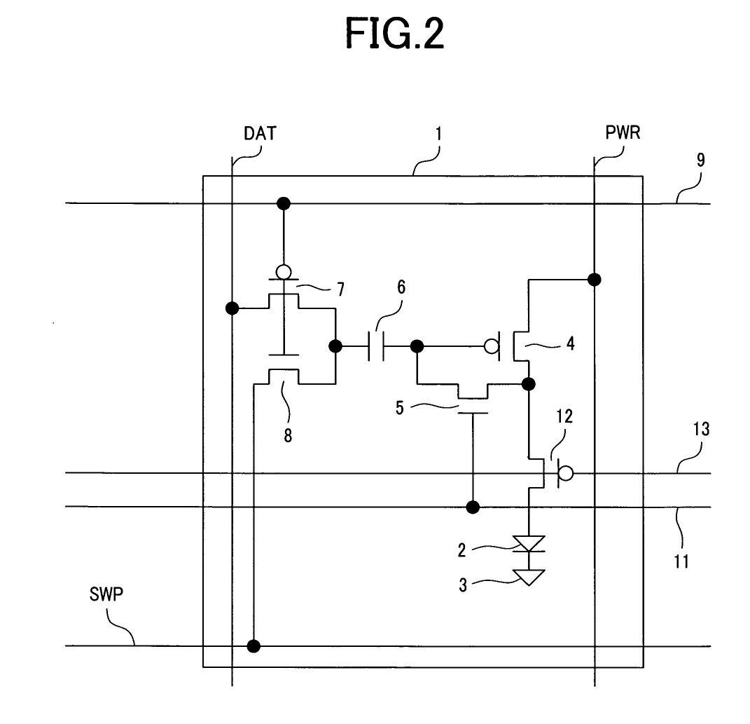

FIG. 2 is a circuit diagram illustrating each of the pixels 1. Each of the pixels 1 is provided with a bottom emission type organic EL element 2. A cathode end of the organic EL element 2 is connected to a common electrode 3. An anode end is connected to the power line PWR through the p-type light-emission control switch 12 and a p-type drive TFT 4. An n-type reset switch 5 is connected between a gate and drain of the drive TFT 4. In addition, the gate of the drive TFT 4 is connected through a storage capacitance 6 to a p-type pixel switch 7 that is connected to the signal line DAT. The gate of the drive TFT 4 is also connected to an n-type triangular wave switch 8 that is connected to the triangular wave line SWP. Incidentally, the reset switch 5 is controlled by the reset switch control line 11; the light-emission control switch 12 is controlled by the light-emission control switch control line 13; and the pixel switch 7 and the triangular wave switch 8 are controlled by the pixel switch control line 9.

Next, a layout configuration of the above-described pixel 1 will be described.

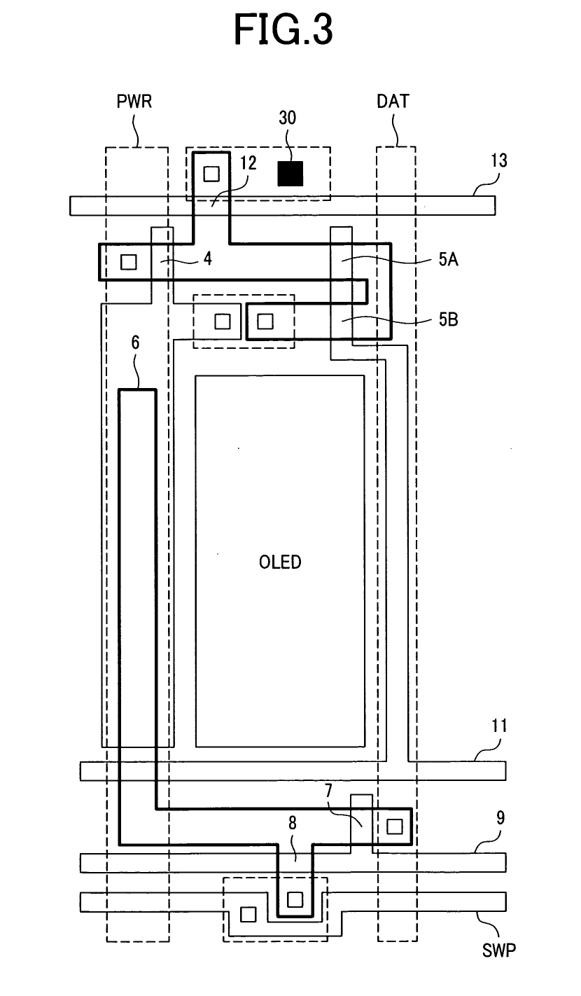

FIG. 3 is a diagram illustrating the layout configuration of the pixel 1. In the figure, each gate electrode is illustrated with a thin solid line; a polycrystalline Si island is illustrated with a bold line; and each low resistant metal line which is mainly made of aluminum (Al) is illustrated with a broken line. A white square indicates a contact hole for a low resistant metal line; and a black square 30 indicates a contact hole for an ITO (Indium-Tin-Oxide) electrode. Incidentally, although the layout of the ITO electrode, that of an organic EL layer, and that of an organic EL common electrode layer, are omitted for purposes of simplicity here, the organic EL emission region OLED which is formed by these layers is shown the middle of the figure.

Since the layout of the pixel shown in FIG. 3 is similar to the circuit diagram shown in FIG. 2, the detailed description thereof will be omitted. However, it is understood that the pixel switch control line 9, the light-emission control switch control line 13, the reset switch control line 11, the triangular wave line SWP, which extend in the horizontal direction, are formed by gate electrodes, and that the signal line DAT and the power line PWR, which extend in the vertical direction, are formed of low resistant metal lines that are mainly made of Al. This is because it is necessary to decrease the resistance of the signal line DAT which requires the high precision in voltage, and to decrease the resistance of the power line PWR which feeds a relatively large electric current.

Moreover, it is also understood that the storage capacitance 6 is located under the power line PWR, and that the reset switch 5 is constituted of two TFT switches 5A, 5B which are serially connected to each other, and that a rectangular organic EL emission region OLED is located in a flat area substantially in the middle of the pixel. The purposes of the above configuration are to secure the placement area of the storage capacitance 6 without sacrificing the organic EL emission region OLED, to reduce a leakage current of the reset switch 5, and to uniformly form the organic EL emission region OLED respectively.

Incidentally, judging from the layout drawing described above, in order to widen the organic EL emission region OLED as much as possible, the first effective measure is to reduce the number of low resistant metal lines that are placed in the longitudinal direction. Moreover, it is desirable to reduce the number of gate electrode lines that are placed in the lateral direction.

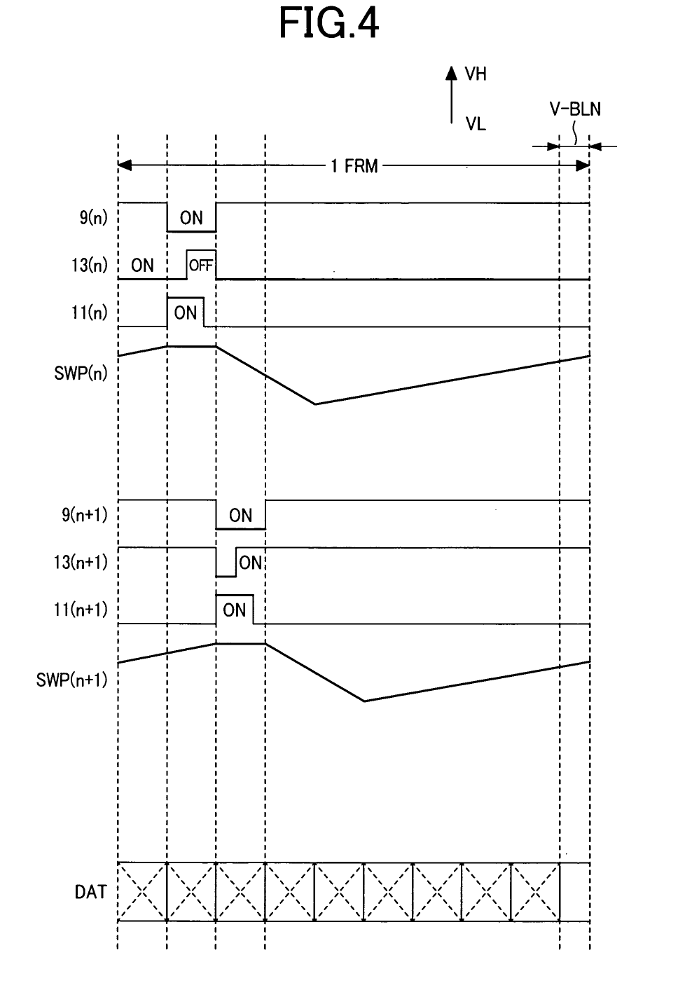

Next, operation of this embodiment will be described with reference to FIGS. 4 through 6.

FIG. 4 is a timing chart illustrating operation of a pixel according to this embodiment. Here, the timing chart illustrates a change in state of the pixel switch control line 9, that of the light-emission control switch control line 13, that of the reset switch control line 11, and that of the triangular wave line SWP during one frame (1 FRM) period. In addition, the (n) indicates a signal of n-th row pixels; and (n+1) indicates a signal of (n+1)-th row pixels. Furthermore, as indicated by VH, VL in the figure, the upper portion shows the high voltage, and the lower portion shows the low voltage. V-BLN denotes a vertical blanking period.

In a pixel that is selected to be written, firstly the pixel switch 7 is switched ON, an n-type triangular wave switch 8 is switched OFF, a p-type light-emission control switch is switched ON, and an n-type reset switch 5 is switched ON by use of the pixel switch control line 9, the light-emission control switch control line 13, and the reset switch control line 11. At this time, as a result of switching ON the light-emission control switch 12 and the reset switch 5, an electric current flows from the power line PWR to the organic EL element 2 through the diode-connected drive TFT 4 and the light-emission control switch 12.

Next, if the light-emission control switch 12 is switched OFF by use of the light-emission control switch control line 13, at a point of time at which the voltage of a drain end of the drive TFT 4 becomes equal to the threshold voltage Vth, the drive TFT 4 is turned OFF. At this time, the video signal voltage is input into the signal line DAT, and this signal voltage is then applied to one end of the storage capacitance 6 through the pixel switch 7. Accordingly, the difference between this signal voltage and the threshold voltage Vth is input into the storage capacitance 6.

Next, when the reset switch 5 is switched OFF by use of the reset switch control line. 11, the difference between the signal voltage and the threshold voltage Vth is stored in the storage capacitance 6, and writing of the signal voltage to the pixel is completed.

Next, when writing proceeds to a pixel in the next row, the pixel switch 7 is switched OFF, and the triangular wave switch 8 is switched ON, by use of the pixel switch control line 9. At this point of time, the sweep voltage having a triangular wave form is applied to the triangular wave line SWP. This triangular wave voltage is input through the triangular wave switch 8 into one end of the storage capacitance 6. In addition, the light-emission control switch 12 is switched ON by use of the light-emission control switch control line 13. At this time, if the triangular wave voltage of the triangular wave line SWP is equal to the signal voltage that has been written beforehand, the threshold voltage Vth is regenerated at a gate of the drive TFT 4 through the storage capacitance 6. Therefore, a light emission period of the organic EL element 2 is determined in response to the signal voltage that has already been written. As a result, because the organic EL element 2 emits light for a light emission period corresponding to the video signal voltage, an observer recognizes a gray scale image.

Here, a change in gate voltage of the drive TFT 4 at the time of writing will be described in more detail.

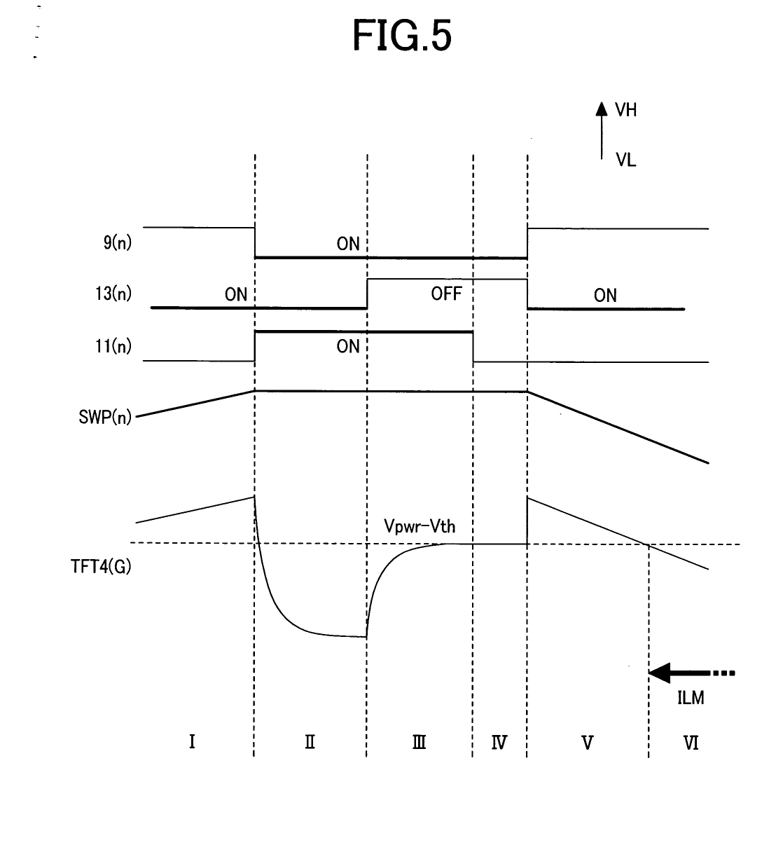

FIG. 5 is a timing chart illustrating operation at the time of writing the signal voltage to a pixel according to this embodiment. Here, the timing chart illustrates a change in state of the pixel switch control line 9, that of the light-emission control switch control line 13, that of the reset switch control line 11, and that of the triangular wave line SWP during one frame period. The (n) indicates a signal of n-th row pixels. In addition, as indicated by VH, VL in the figure, the upper portion shows the high voltage, and the lower portion shows the low voltage. These definitions are the same as those described in FIG. 4.

Further, in FIG. 5, a change in gate voltage of the drive TFT 4 at the time of writing is indicated as TFT 4 (G). In a pixel that is selected to be written, as a result of switching ON the light-emission control switch 12 and the reset switch 5, an electric current flows from the power line PWR to the organic EL element 2 through the diode-connected drive TFT 4 and the light-emission control switch 12. In this case, the gate voltage of the drive TFT 4 is reduced to the gate voltage whose value is commensurate with the electric current of the organic EL element 2 (period II).

Next, if the light-emission control switch 12 is switched OFF by use of the light-emission control switch control line 13, the drain end of the drive TFT 4 is saturated toward the voltage whose value is obtained by subtracting the threshold voltage Vth from the supply voltage Vpwr. At this point of time, the drive TFT 4 is turned OFF (period from III to IV).

After that, when writing proceeds to a pixel in the next row, the pixel switch 7 is switched OFF, and the triangular wave switch 8 is switched ON, by use of the pixel switch control line 9. At this point of time, the sweep voltage having a triangular wave form is applied to the triangular wave line SWP. This triangular wave voltage is input through the triangular wave switch 8 into one end of the storage capacitance 6. Here, based on the difference between the voltage applied to the triangular wave line SWP and the signal voltage that has been written beforehand, the gate voltage of the drive TFT 4 shifts. However, if the triangular wave voltage of the triangular wave line SWP is equal to the signal voltage that has been written beforehand, the threshold voltage Vth is regenerated at the gate of the drive TFT 4 through the storage capacitance 6. Accordingly, the organic EL element 2 is turned ON (period VI). The light emission period of the organic EL element 2 is shown as an ILM period in the figure. By modulating the length of this ILM period using the signal voltage to be written to each pixel, it is possible to display an image on the organic EL display.

Lastly, the relationship between a value of the video signal voltage applied to the signal line DAT and a value of the triangular wave voltage applied to the triangular wave line SWP will be described.

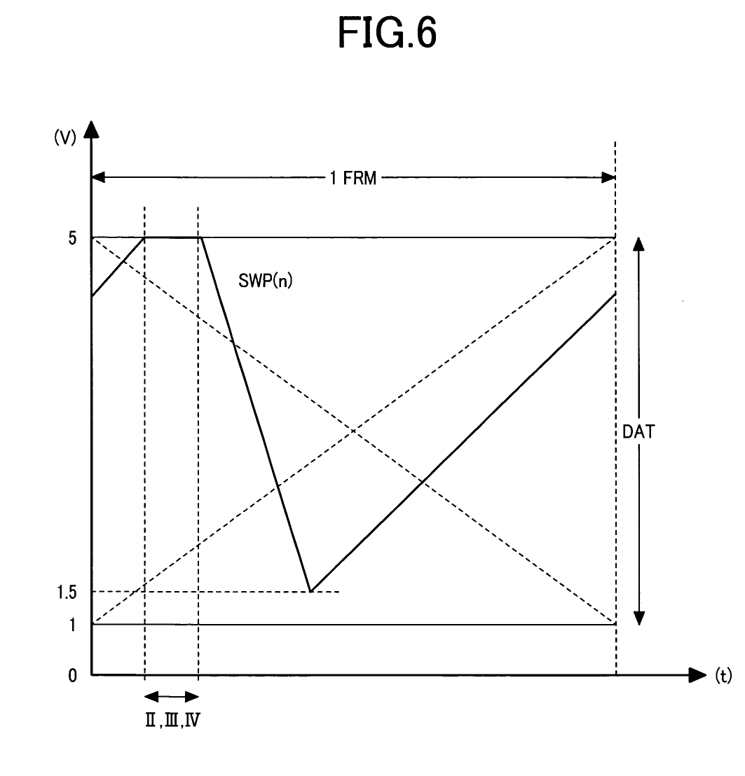

FIG. 6 is a waveform chart illustrating the signal voltage applied to the signal line DAT and the triangular wave voltage applied to the triangular wave line SWP in this embodiment. Here, a change in signal voltage applied to the signal line DAT, and a change in triangular wave voltage applied to the triangular wave line SWP, during one frame period are shown. The (n) indicates a signal of n-th row pixels. Incidentally, the vertical axis indicates the voltage (V), whereas the horizontal axis indicates the time (t). Moreover, in the figure, the upper portion shows the high voltage, and the lower portion shows the low voltage. These definitions are the same as those described in FIG. 4.

As shown in the figure, the signal voltage changes according to video data, and accordingly a value of the signal voltage ranges from 1 to 5 V. On the other hand, the triangular wave voltage is 5 V during a writing period (II, III, IV), and during the other periods, the triangular wave voltage sweeps once in a cycle of one frame period (1 FRM). Here, the maximum voltage of the triangular wave is 5 V; and the minimum voltage is 1.5 V.

During the writing period (II, III, IV), the p-type pixel switch 7 and the n-type triangular wave switch 8 are controlled by use of the pixel switch control line 9. In this case, although both of the TFTs are of an enhancement type, the equivalent gate voltage is applied to both of the TFTs. In the case of the p-type TFT and the n-type TFT, one end of the p-type TFT being connected to one end of the n-type TFT, if the voltage of the other end of the p-type TFT is higher than that of the other end of the n-type TFT, a penetration electric current flows between both of the TFTS.

To be more specific, in this embodiment, if the signal voltage is higher than the triangular wave voltage, a penetration current flows between the signal line DAT and the triangular wave line SWP, which causes the power consumption of the display panel to increase. In this embodiment, in order to avoid such a situation, during the writing period (II, III, IV) in which the p-type pixel switch 7 and the n-type triangular wave switch 8 are controlled by use of the pixel switch control line 9, the triangular wave voltage is set to a value that is the same as the maximum value of the signal voltage. Apparently, the triangular wave voltage may also be set to a value that is higher than the maximum value of the signal voltage. However, in this case, since the number of kinds of voltages that are uselessly used increases, both the triangular wave voltage and the signal voltage are set to the same voltage.

Incidentally, in this embodiment, the minimum voltage of the triangular wave is set to 1.5 V, which is higher than 1 V that is the minimum voltage of the signal voltage. This is because the sufficient margin is obtained when the drive TFT 4 displays black color.

Up to this point, according to the first embodiment, the pixels which are located in the display area, the scanning circuit 22, and the triangular-wave generation circuit 23, are all formed on the same glass substrate by use of the polycrystalline Si-TFT element. In addition, the signal-voltage output circuit 21 is formed by placing, on a glass substrate, an IC chip made of driver monocrystal Si. However, the scanning circuit 22 and the triangular-wave generation circuit 23 may also be formed by the same driver IC chip as that of the signal-voltage output circuit 21, or by a separate driver IC chip. On the other hand, the signal-voltage output circuit 21 may also be formed on the same glass substrate by use of a polycrystalline Si-TFT element. Alternatively, the signal-voltage output circuit 21 may also be formed by, for example, a combination of a driver IC chip placed on the glass substrate and a selector switch or a scanning circuit that uses a polycrystalline Si-TFT element formed on the glass substrate.

Moreover, the material of the transistor is not limited to the polycrystalline-Si. For example, another kind of organic/inorganic semiconductor thin film may also be used for the transistor; and instead of using the glass substrate, another kind of substrate whose surface has insulation properties may also be used.

It is also apparent that the light emitting element is not limited to the organic EL element, and that it is possible to use general light emitting elements such as an inorganic EL element and a FED (Field-Emission Device).

### Second Embodiment

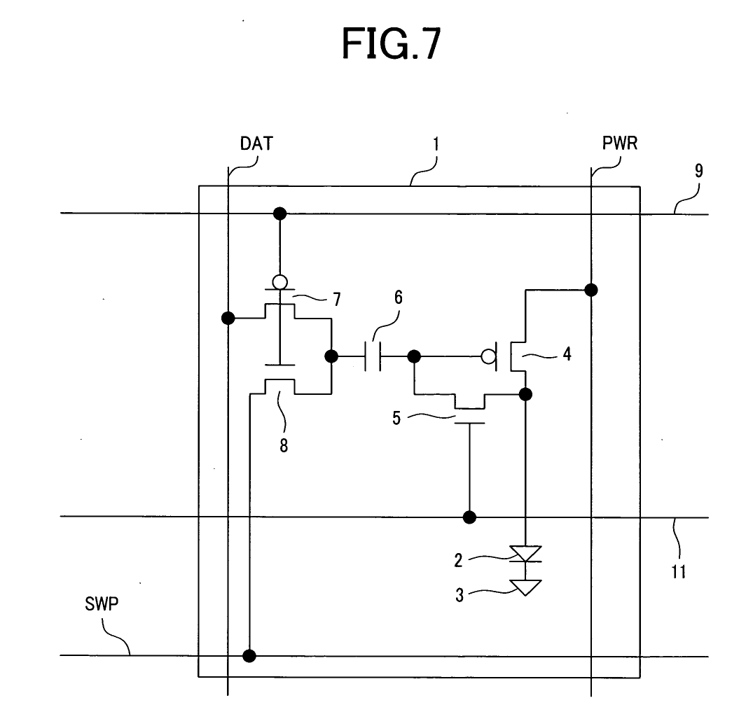

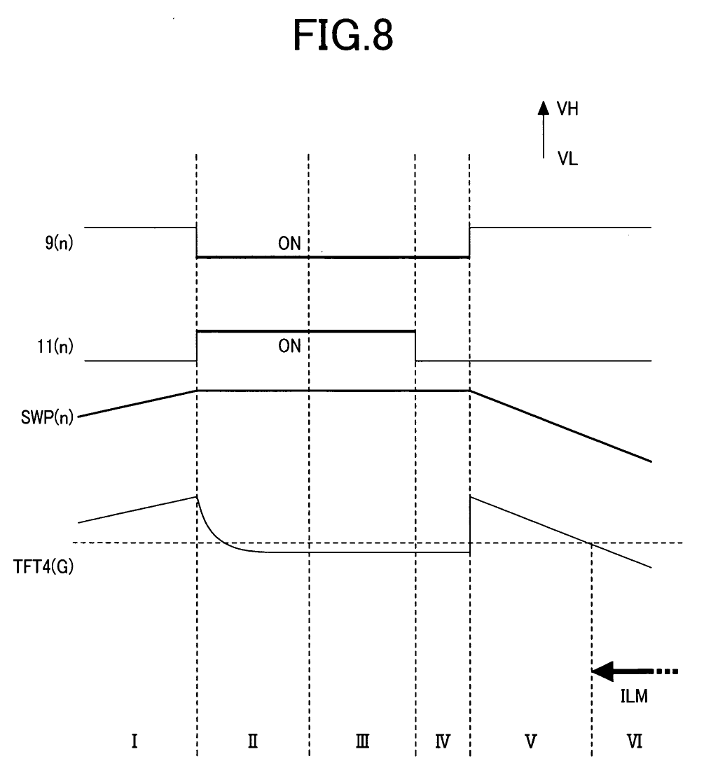

An image display device according to a second embodiment of the present invention will be described with reference to FIGS. 7 and 8.

A configuration of an organic EL display used for portable telephones, a pixel circuit and a basic operation method according to the second embodiment are substantially the same as those described in the first embodiment. The difference between the first embodiment and the second embodiment is that the second embodiment does not include the light-emission control switch control line 13 and the light-emission control switch 12 controlled by the light-emission control switch control line 13. Therefore, only this point will be described below.

FIG. 7 is a diagram illustrating a configuration of a pixel circuit of an image display device according to the second embodiment of the present invention. As described above, it is understood that the difference between FIG. 7 and FIG. 2 is that the second embodiment does not includes the light-emission control switch control line 13 and the light-emission control switch 12 controlled by the light-emission control switch control line 13. Here, FIG. 2 is the diagram illustrating the configuration of each pixel according to the first embodiment.

Next, operation of this embodiment will be described with reference to FIG. 8.

FIG. 8 is a timing chart illustrating operation at the time of writing a signal voltage to a pixel according to this embodiment. Here, the timing chart illustrates a change in state of the pixel switch control line 9, that of the reset switch control line 11, and that of the triangular wave line SWP during one frame period. The (n) indicates a signal of n-th row pixels. In addition, as indicated by VH, VL in the figure, the upper portion shows the high voltage, and the lower portion shows the low voltage. These definitions are the same as those described in FIG. 4.

Further, in FIG. 8, a change in gate voltage of the drive TFT 4 at the time of writing is also indicated as TFT 4 (G). In a pixel that is selected to be written, the pixel switch 7 and the reset switch 5 are first switched ON by use of the pixel switch control line 9 and the reset switch control line 11. As a result, an electric current flows from the power line PWR to the organic EL element 2 through the drive TFT 4 that is diode-connected. At this time, the gate voltage of the drive TFT 4 is set to the middle point voltage of an inverter circuit that is constituted by the organic EL element 2 and the drive TFT 4. This point is the same as the operation of the related art described above (periods II, III).

This state is stored in the storage capacitance 6 when the reset switch 5 is turned OFF by use of the reset switch control line 11 (period IV).

After that, when writing proceeds to a pixel in the next row, the pixel switch 7 is switched OFF, and the triangular wave switch 8 is switched ON, by use of the pixel switch control line 9. At this point of time, the sweep voltage having a triangular wave form is applied to the triangular wave line SWP. This triangular wave voltage is input through the triangular wave switch 8 into one end of the storage capacitance 6. Then, based on the difference between the voltage applied to the triangular wave line SWP and the signal voltage that has been written beforehand, the gate voltage of the drive TFT 4 shifts. However, because of the difference in voltage between the triangular wave voltage of the triangular wave line SWP and the signal voltage that has been written beforehand, the inverter circuit constituted by the organic EL element 2 and the drive TFT 4 is turned ON, which causes the organic EL element 2 to emit light (period VI). Here, it is possible to display an image on the organic EL display by modulating the light emission period of the organic EL element 2, which is the same as the first embodiment.

In comparison with the first embodiment, a penetration current flows into the organic EL element 2 at the time of writing a signal to a pixel in the second embodiment. Therefore, the light emission occurs to some extent, which is a disadvantage. However, since a pixel circuit can be simplified, it is possible to increase the area of the organic EL element, which is an advantage of the second embodiment.

### Third Embodiment

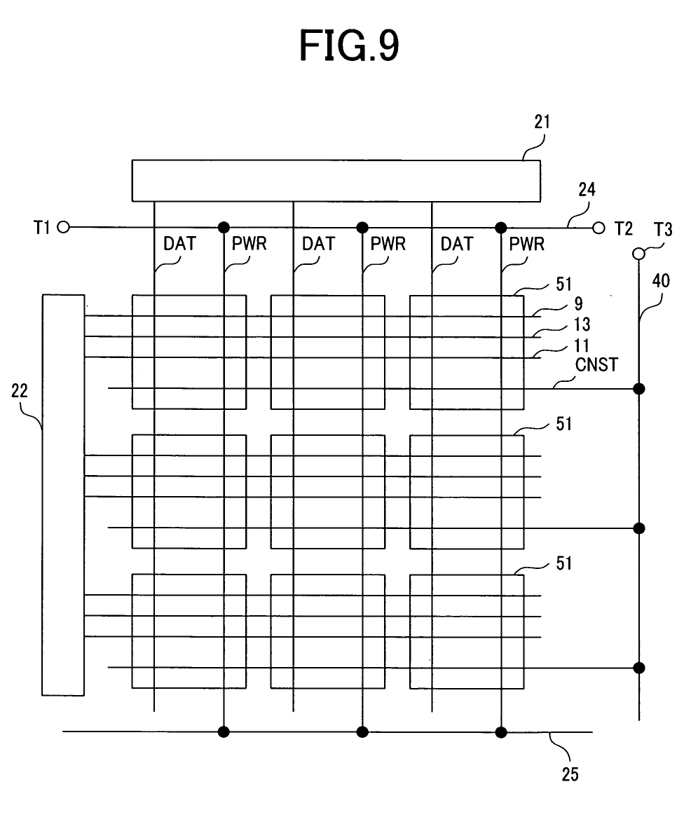

An image display device according to a third embodiment of the present invention will be described with reference to FIGS. 9 through 11.

A configuration of an organic EL display used for portable telephones, a pixel circuit and a basic operation method according to the third embodiment are substantially the same as those described in the first embodiment. The difference between the first embodiment and the third embodiment is that constant voltage lines CNST are used instead of the triangular wave lines SWP. Therefore, only this point will be described below.

FIG. 9 is a diagram illustrating the configuration of the organic EL display used for portable telephones according to the third embodiment. In this embodiment, instead of using the triangular wave line SWP, each constant voltage line CNST is used to connect corresponding pixels 51 in the horizontal direction. One end of the constant voltage line CNST is connected to a constant voltage power line 40. This constant voltage power line 40 is connected to the connection terminal T3 that is located at the edge of the panel.

Next, how each of the pixels 51 is configured will be described.

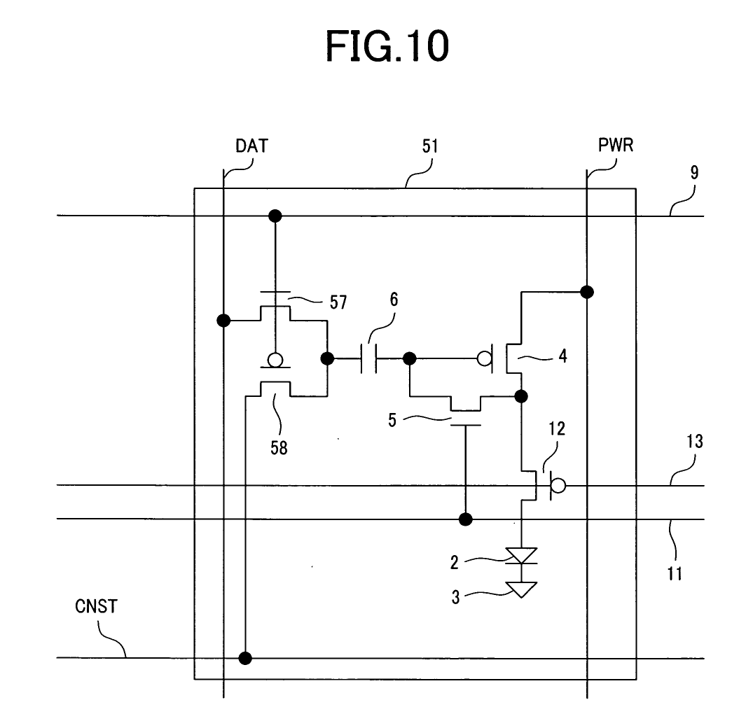

FIG. 10 is a circuit diagram illustrating each of the pixels 51. The difference between the first embodiment and the third embodiment is that a pixel switch 57 connected to the signal line DAT is n-type, and a constant voltage switch 58 connected to the constant voltage line CNST is p-type.

Next, operation of the third embodiment will be described.

In a pixel that is selected to be written, firstly the n-type pixel switch 57 is switched ON, an n-type constant voltage switch 58 is switched OFF, a p-type light-emission control switch 12 is switched ON, and an n-type reset switch 5 is switched ON by use of the pixel switch control line 9, the light-emission control switch control line 13, and the reset switch control line 11. At this time, as a result of switching ON the light-emission control switch 12 and the reset switch 5, an electric current flows from the power line PWR to the organic EL element 2 through the diode-connected drive TFT 4 and the light-emission control switch 12.

Next, if the light-emission control switch 12 is switched OFF by use of the light-emission control switch control line 13, at a point of time at which the voltage of a drain end of the drive TFT 4 becomes equal to the threshold voltage Vth, the drive TFT 4 is turned OFF. At this time, the video signal voltage is input into the signal line DAT, and this signal voltage is then applied to one end of the storage capacitance 6 through the pixel switch 57. Accordingly, the difference between this signal voltage and the threshold voltage Vth is input into the storage capacitance 6.

Next, when the reset switch 5 is switched OFF by use of the reset switch control line 11, the difference between the signal voltage and the threshold voltage Vth is stored in the storage capacitance 6, and writing of the signal voltage to the pixel is completed.

Next, when writing proceeds to a pixel in the next row, the pixel switch 57 is switched OFF, and the constant voltage switch 58 is switched ON, by use of the pixel switch control line 9, respectively. At this time, the specified constant voltage is applied to the constant voltage line CNST. This constant voltage is input through the constant voltage switch 58 into one end of the storage capacitance 6. In addition, the light-emission control switch 12 is switched OFF by use of the light-emission control switch control line 13. At this time, the voltage corresponding to the difference in voltage between the constant voltage of the constant voltage line CNST and the signal voltage written beforehand is generated at a gate of the drive TFT 4 through the storage capacitance 6. Therefore, a driving current of the organic EL element 2 is determined in response to the signal voltage that has already been written. As a result, since the organic EL element 2 emits light with the emission intensity corresponding to the video signal voltage, an observer recognizes a gray scale image.

Lastly, the relationship between a value of the signal voltage applied to the signal line DAT and a value of the constant voltage applied to the constant voltage line CNST will be described.

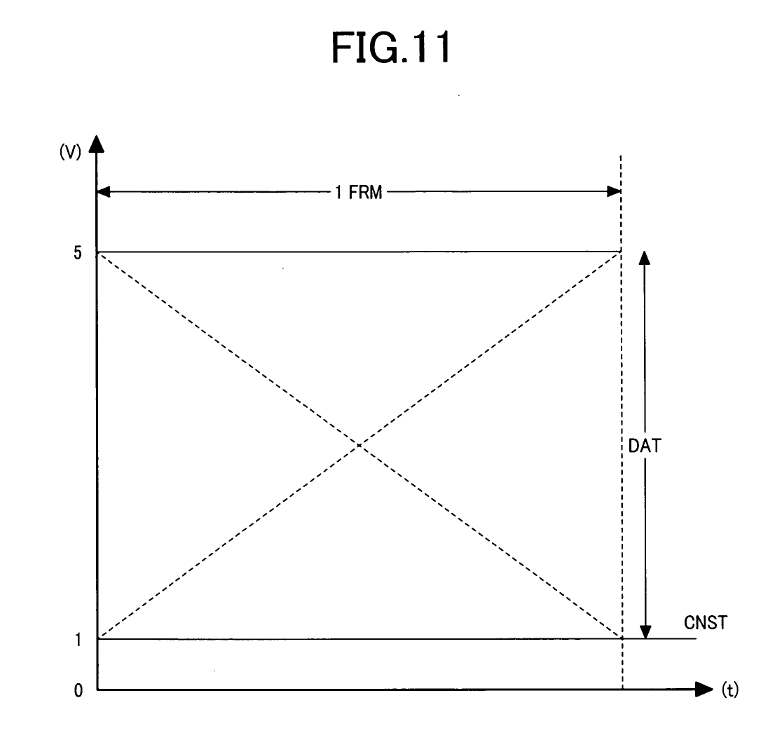

FIG. 11 is a waveform chart illustrating the signal voltage applied to the signal line DAT and the constant voltage applied to the constant voltage line CNST according to the third embodiment. Here, FIG. 11 illustrates a change in value of the signal voltage applied to the signal line DAT, and that of the triangular wave voltage applied to the triangular wave line SWP, during one frame period (1 FRM). Moreover, in the figure, the upper portion shows the high voltage, and the lower portion shows the low voltage. These definitions are the same as those described in FIG. 4.

As shown in the figure, the signal voltage changes-according to video data, and accordingly a value of the signal voltage ranges from 1 to 5 V. On the other hand, the constant voltage applied to the constant voltage line CNST is always 1 V.

During a writing period, the n-type pixel switch 57 and the p-type constant voltage switch 58 are controlled by use of the pixel switch control line 9. In this case, although both of the TFTs are enhancement type TFTs, the same gate voltage is applied to both of the TFTs. In the case of the p-type TFT and the n-type TFT, one end of the p-type TFT being connected to one end of the n-type TFT, if the voltage of the other end of the p-type TFT is higher than that of the other end of the n-type TFT, a penetration electric current flows between both of the TFTs. To be more specific, in this embodiment, if the signal voltage is lower than the constant voltage that is applied to the constant voltage line CNST, a penetration current flows between the signal line DAT and the constant voltage line CNST, which causes the power consumption of the display panel to increase.

In this embodiment, in order to avoid such a situation, the constant voltage applied to the constant voltage line CNST is set to a value that is the same as the minimum value of the signal voltage. Apparently, the constant voltage applied to the constant voltage line CNST may also be set to a value that is higher than or equal to the minimum value of the signal voltage. However, in this case, since the number of kinds of voltages which are uselessly used increases, both are set to the same voltage here.

In this embodiment, since a triangular wave is not used, an image is easily influenced by variations in properties of the drive TFT 4, which is a disadvantage. On the other hand, if variations in properties of the drive TFT 4 are sufficiently small, a circuit configuration of the display becomes simple, which is an advantage of this embodiment.

### Fourth Embodiment

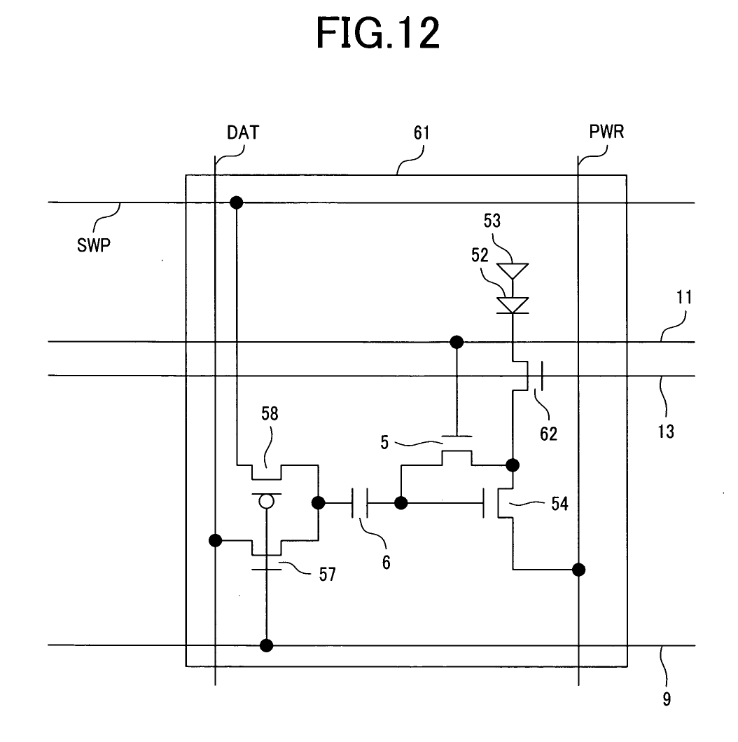

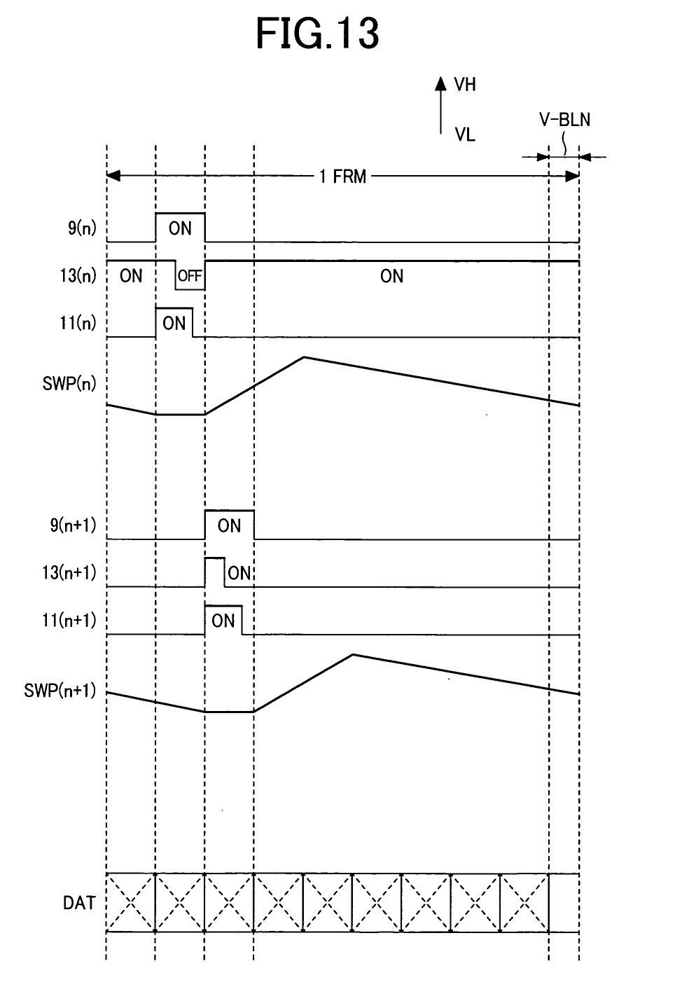

An image display device according to a fourth embodiment of the present invention will be described with reference to FIGS. 12 and 13.

A configuration of an organic EL display used for portable telephones, a pixel circuit and a basic operation method according to this embodiment are substantially the same as those described in the first embodiment. As shown in FIG. 12, the difference between the first embodiment and the fourth embodiment is that the positive and negative voltage relationship in the pixel 61 is reversed. Therefore, only this point will be described below.

How each of the pixels 61 is configured will be described as below.

FIG. 12 is a circuit diagram illustrating each of the pixels 61. Each of the pixels 61 is provided with a bottom emission type organic EL element 52. An anode end of the organic EL element 52 is connected to the common electrode 53 and a cathode end thereof is connected to the power line PWR through the n-type light-emission control switch 62 and the n-type drive TFT 54. An n-type reset switch 5 is connected between a gate and drain of the drive TFT 54.

In addition, the gate of the drive TFT 54 is connected through the storage capacitance 6 to the n-type pixel switch 57 that is connected to the signal line DAT. The gate of the drive TFT 54 is also connected to the p-type triangular wave switch 58 that is connected to the triangular wave line SWP. Incidentally, the reset switch 5 is controlled by the reset switch control line 11; the light-emission control switch 62 is controlled by the light-emission control switch control line 13; and the pixel switch 57 and the triangular wave switch 58 are control-led by the pixel switch control line 9.

Next, operation of the fourth embodiment will be described with reference to FIG. 13.

FIG. 13 is a timing chart illustrating operation of a pixel according to this embodiment. Here, the timing chart illustrates a change in state of the pixel switch control line 9, that of the light-emission control switch control line 13, that of the reset switch control line 11, and that of the triangular wave line SWP during one frame period. The (n) indicates a signal of n-th row pixels. In addition, as indicated by VH, VL in the figure, the upper portion shows the high voltage, and the lower portion shows the low voltage. These definitions are the same as those described in FIG. 4.

In a pixel that is selected to be written, firstly the pixel switch 57 is switched ON, the p-type triangular wave switch 58 is switched OFF, the n-type light-emission control switch 62 is switched ON, and the n-type reset switch 5 is switched ON by use of the pixel switch control line 9, the light-emission control switch control line 13, and the reset switch control line 11. At this time, as a result of switching ON the light-emission control switch 62 and the reset switch 5, an electric current flows from the organic EL element 52 to the power line PWR through the diode-connected drive TFT 54 and the light-emission control switch 62.

Next, if the light-emission control switch 62 is switched OFF by use of the light-emission control switch control line 13, at a point of time at which the voltage of the drain end of the drive TFT 54 becomes equal to the threshold voltage Vth, the drive TFT 54 is turned OFF. At this time, the video signal voltage is input into the signal line DAT, and this signal voltage is then applied to one end of the storage capacitance 6 through the pixel switch 57. Accordingly, the difference between this signal voltage and the threshold voltage Vth is input into the storage capacitance 6. Next, when the reset switch 5 is switched OFF by use of the reset switch control line 11, the difference between this signal voltage and the threshold voltage Vth is stored in the storage capacitance 6, and writing of the signal voltage to the pixel is completed.

Next, when writing proceeds to a pixel in the next row, the pixel switch 57 is switched OFF, and the triangular wave switch 58 is switched ON, by use of the pixel switch control line 9. At this point of time, the sweep voltage having a triangular wave form is applied to the triangular wave line SWP. This triangular wave voltage is input through the triangular wave switch 58 into one end of the storage capacitance 6. In addition, the light-emission control switch 62 is switched OFF by use of the light-emission control switch control line 13.

Here, if the triangular wave voltage of the triangular wave line SWP is equal to the signal voltage that has been written beforehand, the threshold voltage Vth is regenerated at the gate of the drive TFT 54 through the storage capacitance 6. Therefore, a light emission period of the organic EL element 52 is determined in response to the signal voltage that has already been written. As a result, since the organic EL element 52 emits light for a light emission period corresponding to the video signal voltage, an observer recognizes a gray scale image.

During a writing period, the n-type pixel switch 57 and the p-type the triangular wave switch 58 are controlled by use of the pixel switch control line 9. In this case, although both of the TFTs are enhancement type TFTs, the equal gate voltage is applied to both of the TFTs. In the case of the p-type TFT and the n-type TFT, one end of the p-type TFT being connected to one end of the n-type TFT, if the voltage of the other end of the p-type TFT is higher than that of the other end of the n-type TFT, a penetration electric current flows between both of the TFTS. To be more specific, in this embodiment, if the signal voltage is lower than the triangular wave voltage, a penetration current flows between the signal line DAT and the triangular wave line SWP, which causes the power consumption of the display panel to increase.

In this embodiment, in order to avoid such a situation, during the writing period in which the n-type pixel switch 57 and the p-type triangular wave switch 58 are controlled by use of the pixel switch control line 9, the triangular wave voltage is set to a value that is the same as the minimum value of the signal voltage. It is apparent that the triangular wave voltage may also be set to a value that is higher than or equal to the minimum value of the signal voltage. However, in this case, since the number of kinds of voltages which are uselessly used increases, both are set to the same voltage here.

Incidentally, in the fourth embodiment, the signal voltage is set to a value ranging from 1 V to 5V; and the triangular wave voltage is set to a value ranging from 1 V to 4.5V, which is lower than 5 V that is the maximum voltage of the signal voltage. This is because the sufficient margin is obtained when the drive TFT 54 displays black color.

### Fifth Embodiment

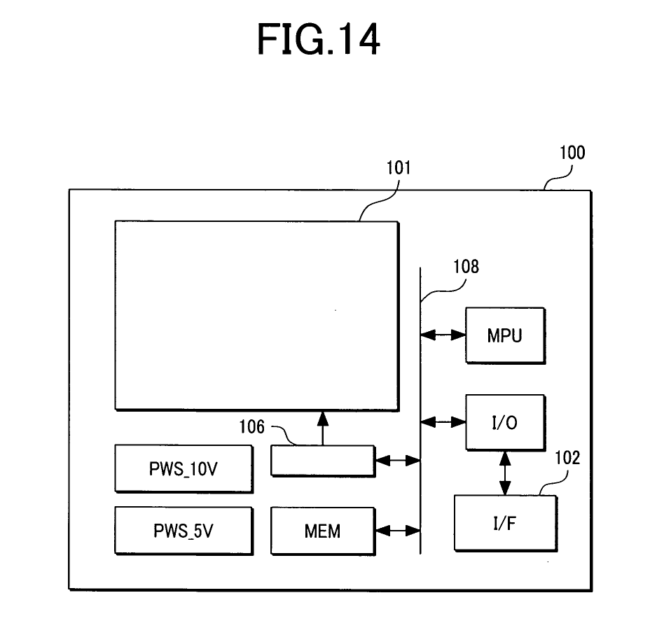

An image display device according to a fifth embodiment of the present invention will be described with reference to FIG. 14.

FIG. 14 is a diagram illustrating a configuration of a TV image display device 100 according to the fifth embodiment. Compressed image data and the like is input, as radio data, into a wireless interface (I/F) circuit 102 from the external. The wireless I/F circuit 102 receives a terrestrial digital signal or the like. The output of the wireless I/F circuit 102 is connected to a data bus 108 through an input/output (I/O) circuit. In addition to the wireless I/F circuit 102, a microprocessor (MPU), a display panel controller 106, a frame memory MM and the like are connected to the data bus 108. Moreover, the output of the display panel controller 106 is connected to the input of an organic EL display panel 101. Incidentally, the TV image display device 100 is further provided with a 5 V power supply unit PWS_{—}5V and a 10 V power supply unit PWS_{—}10V. Incidentally, the organic EL display panel 101 has the same configuration as that described in the first embodiment, and operates in the same manner as the operation in the first embodiment. Therefore, the description of the internal configuration and operation will be omitted here.

Operation of this embodiment will be described as below. Firstly, the wireless I/F circuit 102 receives compressed image data from the external according to a command. Then, the wireless I/F circuit 102 transmits this image data to the microprocessor MPU and the frame memory MM through an I/O circuit. Upon reception of an instruction from a user, the microprocessor MPU drives the entire TV image display device 100 to decode the compressed image data, perform signal processing, and display information, as required. It is possible to temporarily store, in the frame memory MM, the image data that has been subjected to signal processing.

Here, when the microprocessor MPU issues a display instruction, image data is input from the frame memory MM into the organic EL display panel 101 through the display panel controller 106 according to the instruction. After that, the organic EL display panel 101 displays the input image data in real time. At this time, the display panel controller 106 outputs a specified timing pulse required to concurrently display the image.

Incidentally, the operation, in which the organic EL display panel 101 uses these signals to display the input image data in real time, is performed as described in the first embodiment.

In addition, the power supply units PWS_{—}5V, PWS_{—}10V include a secondary battery, which supplies electric power for driving the entire image display terminal 100. According to this embodiment, it is possible to provide the image display terminal 100 that is capable of displaying an image with high brightness and low power.

Incidentally, the organic EL display panel described in the first embodiment is used as an image display device in this embodiment. However, besides the organic EL display panel, it is apparent that it is possible to use the various display panels as described in the other embodiments of the present invention. However, in this case, it is needless to say that it is necessary to make some changes to the circuit based on the structure of each individual organic EL display panel.

What is claimed is:

1. An image display device comprising:
means for generating a video signal voltage;
means for generating a pixel driving voltage;
a pixel that includes a light emitting element whose brightness is controlled by the potential difference between the video signal voltage and the pixel driving voltage, and control means for controlling the brightness of the light emitting element; and
a display unit on which a plurality of pixels are arranged;
wherein:
the pixel includes a pair of switching means for alternatively selecting and inputting one of the video signal voltage and the pixel driving voltage; and
the pair of switching means have a structure that is controlled by a common switch control line.

2. The image display device according to claim 1, wherein the light emitting element is an organic EL element.

3. The image display device according to claim 1, wherein the pair of switching means are polycrystalline Si-TFTs.

4. The image display device according to claim 1, wherein the pixel is formed on an insulating substrate.

5. The image display device according to claim 1, wherein:
the brightness control means that is formed on each pixel includes:
a capacitance, one end of which has the pair of switching means;
a drive TFT whose gate is connected to the other end of the capacitance;
a power line that is connected to one end of a source-drain path of the drive TFT; and
a reset TFT that is connected to the light emitting element that is connected to the other end of the source-drain path of the drive TFT, and that is connected to a point between a gate of the drive TFT and the other end of the source-drain path of the drive TFT.

6. The image display device according to claim 5, wherein the reset TFT is an n-type TFT.

7. The image display device according to claim 5, wherein a plurality of the reset TFTs are serially connected.

8. The image display device according to claim 1, wherein:
the pair of switching means that are formed on each pixel includes a p-type TFT for inputting the video signal voltage, and an n-type TFT for inputting the pixel driving voltage; and
when the switch control line is switched, the pixel driving voltage generation means sets the pixel driving voltage to a voltage higher than or equal to the video signal voltage.

9. The image display device according to claim 8, wherein both of the TFTs that constitute the pair of switching means are enhancement type TFTs.

10. The image display device according to claim 1, wherein:
the pair of switching means that are formed on each pixel includes an n-type TFT for inputting the video signal voltage, and a p-type TFT for inputting the pixel driving voltage; and
when the switch control line is switched, the pixel driving voltage generation means sets the pixel driving voltage to a voltage lower than or equal to the video signal voltage.

11. The image display device according to claim 10, wherein both of the TFTs that constitute the pair of switching means are enhancement type TFTs.

12. The image display device according to claim 1, wherein the pixel driving voltage has a substantially triangular wave form.

13. The image display device according to claim 1, wherein a phase of a wave form of the pixel driving voltage differs for each pixel row that is parallel to the switch control line.

14. The image display device according to claim 1, wherein when switching is performed by the selected switch control line, the pixel driving voltage input in a pixel through the switch control line is constant.

15. The image display device according to claim 1, wherein the pixel driving voltage is always constant.

16. The image display device according to claim 1, wherein the video signal voltage generation means is formed of a monocrystal Si-IC.

17. An image display device comprising:
means for storing a video signal;
means for generating a power-supply voltage;
means for generating a video signal voltage;
means for generating a pixel driving voltage;
a pixel that includes a light emitting element whose brightness is controlled by the potential difference between the video signal voltage and the pixel driving voltage, and control means for controlling the brightness of the light emitting element; and
a display unit on which a plurality of pixels are arranged;
wherein:
the pixel includes a pair of switching means for alternatively selecting and inputting one of the video signal voltage and the pixel driving voltage; and
the pair of switching means have a structure that is controlled by a common switch control line.
